(19) United States
(12) Patent Application Publication
(10) Pub. No.: US 2021/0358388 A1
(43) Pub. Date: Nov. 18, 2021

(54) PIXEL DRIVING CIRCUIT AND DISPLAY DEVICE

(71) Applicant: Shenzhen China Star Optoelectronics Semiconductor Display Technology Co., Ltd., Shenzhen Guangdong (CN)

(72) Inventor: Lijun Zhang, Shenzhen, Guangdong (CN)

(21) Appl. No.: 16/603,452

(22) PCT Filed: May 21, 2019
(86) PCT No.: PCT/CN2019/087727

§ 371 Date: Oct. 7, 2019

(30) Foreign Application Priority Data
Apr. 22, 2019 (CN) 201910324428.4

(51) Int. Cl. G09G 3/32

(52) U.S. Cl. CPC G09G 3/32; G09G 2320/0233; G09G 2300/0819; G09G 2300/0842; G09G 2300/0452

(57) ABSTRACT

The present application relates to a pixel driving circuit and a display device. The pixel driving circuit includes a blue light sub-pixel, a green light sub-pixel, and a red light sub-pixel in parallel with each other. The blue light sub-pixel includes at least one blue LED, the green light sub-pixel includes at least one green LED, the red light sub-pixel includes at least two red LEDs in series with each other, and a number of the red LEDs is greater than a number of the blue LED and a number of the green LED.

### FIELD OF INVENTION

The present application relates to the technical field of display, and especially to a pixel driving circuit and display device

### BACKGROUND OF INVENTION

Different from the voltage driving of liquid crystal display panels, micro light emitting diode (micro LED) panels adopt voltage-to-current converting driving, namely providing a voltage signal at an input terminal that passes a pixel circuit and is converted into current transmitting through LEDs, thereby the current value transmitting through the LEDs in each pixel can be changed by changing an input voltage signal, such that the purpose of controlling the brightness and gray scale of the panel can be achieved.

However, because luminous efficiency of red and green and blue micro LEDs differs widely, and especially the luminous efficiency of red LEDs is significantly low, when reaching a standard white point, usually the current transmitting through red LEDs is 4 to 5 times greater than that transmitting through blue LEDs and green LEDs. That is to say, when displaying white or red pictures, the total current transmitting through the panel is greater, the voltage attenuation from the voltage signal input terminal to the distant pixels is more significant, and therefore the brightness uniformity of the panel becomes worse.

### SUMMARY OF INVENTION

The present application is to provide a pixel driving circuit and display device to decrease the driving current of the red light sub-pixel under the condition of reaching the same level of brightness and therefore decrease the total current in the display panel to decrease the voltage attenuation and increase the uniformity of light emitted by the display panel.

In order to overcome the above problem, an embodiment of the present application provides a pixel driving circuit that includes a blue light sub-pixel, a green light sub-pixel, and a red light sub-pixel in parallel with each other; wherein the blue light sub-pixel includes at least one blue light emitting diode (LED), the green light sub-pixel includes at least one green LED, the red light sub-pixel includes at least two red LEDs in series with each other, and a number of the red LEDs is greater than a number of the blue LED and a number of the green LED.

Wherein the pixel driving circuit further includes a first transistor, wherein a first terminal of the first transistor is connected to one terminal of the red light sub-pixel, a second terminal of the first transistor is input with a first preset voltage, other terminal of the red light sub-pixel is input with a second preset voltage, and a gate of the first transistor is configured to receive a data signal to control light emitted by the red light sub-pixel; a storage capacitor, wherein one terminal of the storage capacitor is connected to the gate of the first transistor, and other terminal of the storage capacitor is connected to the first terminal of the first transistor or the second terminal of the first transistor; a second transistor, wherein a gate of the second transistor is configured to receive a scan signal, an input terminal of the second transistor is configured to receive the data signal, an output terminal of the second transistor is connected to the one terminal of the storage capacitor, and the data signal is transmitted to the gate of the first transistor passing the one terminal of the storage capacitor.

Wherein the first terminal is one of a source and a drain of the first transistor, and the second terminal is the other of the source and the drain of the first transistor.

Wherein when the other terminal of the storage capacitor is connected to the first terminal of the first transistor, the first preset voltage is greater than the second preset voltage, and the pixel driving circuit further includes a third transistor, wherein an input terminal of the third transistor is configured to receive a compensation data signal, an output terminal of the third transistor is connected to the other terminal of the storage capacitor, and a gate of the third transistor is configured to receive a compensation scan signal; wherein when the red light sub-pixel is lit, the compensation data signal transmitting through the input terminal of the third transistor and the data signal transmitting through the input terminal of the second transistor together charge the storage capacitor, and the storage capacitor being finished charging discharges to make the red light sub-pixel illuminate.

Wherein the input terminal of the second transistor is one of a source and a drain of the second transistor, the output terminal of the second transistor is the other of the source and the drain of the second transistor, the input terminal of the third transistor is one of a source and a drain of the third transistor, and the output terminal of the third transistor is the other of the source and the drain of the third transistor.

Wherein a voltage value provided by the compensation data signal is less than an illuminated voltage value of the red light sub-pixel.

Wherein the pixel driving circuit further includes a first scan line connected to the gate of the second transistor and configured to provide the scan signal; a first data line connected to the input terminal of the second transistor and configured to provide the data signal; a second scan line connected to the gate of the third transistor and configured to provide the compensation scan signal; a second data line connected to the input terminal of the third transistor and configured to provide the compensation data signal.

Wherein a driving time of the first scan line is the same as a driving time of the second scan line, and a driving time of the first data line is the same as a driving time of the second data line.

Wherein a difference between the first preset voltage and the second preset voltage is greater than or equal to a threshold voltage of the first transistor.

Wherein the at least one blue LED is one blue LED, the at least one green LED is one green LED, and the at least two red LEDs in series with each other are two red LEDs in series with each other.

In order to overcome the above problem, an embodiment of the present application further provides a display device, and the display device includes a pixel driving circuit that includes a blue light sub-pixel, a green light sub-pixel, and a red light sub-pixel in parallel with each other; wherein the blue light sub-pixel includes at least one blue LED, the green light sub-pixel includes at least one green LED, the red light sub-pixel includes at least two red LEDs in series with each other, and a number of the red LEDs is greater than a number of the blue LED and a number of the green LED.

Wherein the pixel driving circuit further includes a first transistor, wherein a first terminal of the first transistor is connected to one terminal of the red light sub-pixel, a second terminal of the first transistor is input with a first preset voltage, other terminal of the red light sub-pixel is input with a second preset voltage, and a gate of the first transistor is configured to receive a data signal to control light emitted by the red light sub-pixel; a storage capacitor, wherein one terminal of the storage capacitor is connected to the gate of the first transistor, and other terminal of the storage capacitor is connected to the first terminal of the first transistor or the second terminal of the first transistor; a second transistor, wherein a gate of the second transistor is configured to receive a scan signal, an input terminal of the second transistor is configured to receive the data signal, an output terminal of the second transistor is connected to the one terminal of the storage capacitor, and the data signal is transmitted to the gate of the first transistor passing the one terminal of the storage capacitor.

Wherein the first terminal is one of a source and a drain of the first transistor, and the second terminal is the other of the source and the drain of the first transistor.

Wherein when the other terminal of the storage capacitor is connected to the first terminal of the first transistor, the first preset voltage is greater than the second preset voltage, and the pixel driving circuit further includes a third transistor, wherein an input terminal of the third transistor is configured to receive a compensation data signal, an output terminal of the third transistor is connected to the other terminal of the storage capacitor, and a gate of the third transistor is configured to receive a compensation scan signal; wherein when the red light sub-pixel is lit, the compensation data signal transmitting through the input terminal of the third transistor and the data signal transmitting through the input terminal of the second transistor together charge the storage capacitor, and the storage capacitor being finished charging discharges to make the red light sub-pixel illuminate.

Wherein the input terminal of the second transistor is one of a source and a drain of the second transistor, the output terminal of the second transistor is the other of the source and the drain of the second transistor, the input terminal of the third transistor is one of a source and a drain of the third transistor, and the output terminal of the third transistor is the other of the source and the drain of the third transistor.

Wherein a voltage value provided by the compensation data signal is less than an illuminated voltage value of the red light sub-pixel.

Wherein the pixel driving circuit further includes a first scan line connected to the gate of the second transistor and configured to provide the scan signal; a first data line connected to the input terminal of the second transistor and configured to provide the data signal; a second scan line connected to the gate of the third transistor and configured to provide the compensation scan signal; a second data line connected to the input terminal of the third transistor and configured to provide the compensation data signal.

Wherein a driving time of the first scan line is the same as a driving time of the second scan line, and a driving time of the first data line is the same as a driving time of the second data line.

Wherein a difference between the first preset voltage and the second preset voltage is greater than or equal to a threshold voltage of the first transistor.

Wherein the at least one blue LED is one blue LED, the at least one green LED is one green LED, and the at least two red LEDs in series with each other are two red LEDs in series with each other.

The beneficial effect of the present application is that distinctive from the conventional technology, the pixel driving circuit provided by the present application includes a blue light sub-pixel, a green light sub-pixel and a red light sub-pixel in parallel with each other. The blue light sub-pixel includes at least one blue LED, the green light sub-pixel includes at least one green LED, and the red light sub-pixel includes at least two red LEDs in series with each other. The number of the red LEDs is greater than the number of the blue LED and the number of the green LED. In this way, through replacing a single LED with multiple red LEDs in series with each other, the driving current of the red light sub-pixel can be decreased under the condition of reaching the same level of brightness and therefore the total current in the display panel is decreased and the uniformity of light emitted by the display panel is increased.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which figures those skilled in the art can derive further figures without making any inventive efforts.

FIG. 1 is a structural schematic diagram of the pixel driving circuit according to an embodiment of the present application.

FIG. 2 is another structural schematic diagram of the pixel driving circuit according to an embodiment of the present application.

FIG. 3 is another structural schematic diagram of the pixel driving circuit according to an embodiment of the present application.

FIG. 4 is another structural schematic diagram of the pixel driving circuit according to an embodiment of the present application.

FIG. 5 is a waveform diagram of the scan signal, the data signal, the compensation scan signal and the compensation data signal in FIG. 4 varying with respective to the clock signal.

FIG. 6 is another structural schematic diagram of the pixel driving circuit according to an embodiment of the present application.

FIG. 7 is a structural schematic diagram of the display device according to an embodiment of the present application.

### DETAILED DESCRIPTION OF PREFERRED EMBODIMENTS

The embodiments of the present disclosure are described in detail hereinafter. Examples of the described embodiments are given in the accompanying drawings. It should be noted that, the following embodiments are intended to illustrate and interpret the present disclosure, which shall not be construed as causing limitations to the present disclosure. Similarly, the following embodiments are part of the embodiments of the present disclosure and are not the whole embodiments, and all other embodiments those skilled in the art obtain without making any inventive efforts are within the scope protected by the present application.

Because the luminous efficiency of red and green and blue micro light emitting diodes (LEDs) differs widely, and especially the luminous efficiency of red LEDs is significantly low, when reaching a standard white point, usually the current transmitting through red LEDs is 4 to 5 times greater than that transmitting through blue LEDs and green LEDs. That is to say, when displaying white or red pictures, the total current transmitting through the panel is greater, the voltage attenuation from the voltage signal input terminal to the distant pixels is more significant, and therefore the brightness uniformity of the panel becomes worse. In order to overcome the above technical problem, the technical approach adopted by the present application is to provide a pixel driving circuit to decrease the driving current of the red light sub-pixel under the condition of reaching the same level of brightness and therefore decrease the total current in the display panel to decrease the voltage attenuation and increase the uniformity of light emitted by the display panel.

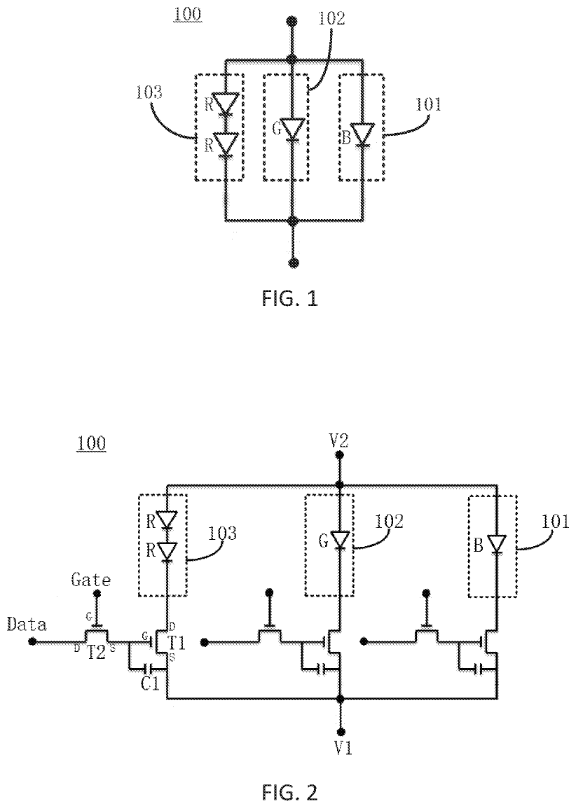

Referring to FIG. 1, FIG. 1 is a structural schematic diagram of the pixel driving circuit according to an embodiment of the present application. As shown in FIG. 1, the pixel driving circuit 100 includes a blue light sub-pixel 101, a green light sub-pixel 102 and a red light sub-pixel 103 in parallel with each other. The blue light sub-pixel 101 includes at least one blue LED B, the green light sub-pixel 102 includes at least one green LED G, and the red light sub-pixel 103 includes at least two red LEDs R in series with each other.

In the present embodiment, a number of the red LEDs R is greater than a number of the blue LED B and a number of the green LED G. For example, the number of the red LEDs R is 2, and the numbers of the blue LED B and the green LED G are both 1. Comparing to the case where the numbers of the red LEDs R, the blue LED B and the green LED G are equal, for example, the numbers are all 1, the present embodiment can adopt less current to drive the red light sub-pixel 103 under the condition of reaching the same level of brightness, and therefore can decrease the total current in a display panel, decrease the voltage attenuation and increase the uniformity of light emitted by the display panel.

In the present embodiment, the red light sub-pixel 103 can include two, three or four red LEDs R in series, and advantageously the multiple red LEDs R in series are products having the same specification or of the same model, or they have the same breakover voltage, to ensure the uniformity of light emitted by the red light sub-pixel 103.

In particular, the number of the blue LED B and that of the green LED G can be equal or different, and when they are different, the numbers are inversely proportional to their respective light emitting efficiency. For example, if the light emitting efficiency of the blue LED B is lower than that of the green LED G, the number of the blue LED B is greater than that of the green LED G. When the blue light sub-pixel 101 includes multiple blue LEDs B or when the green light sub-pixel 102 includes multiple green LEDs G, the multiple blue LEDs B or the multiple green LEDs G are in series. Furthermore, under the condition that the number of the red LEDs R is greater than that of the blue LED B and that of the green LED G, properly increasing the number of the blue LED B and that of the green LED G can further decrease the total current in the display panel, decrease the voltage attenuation and increase the uniformity of light emitted by the display panel.

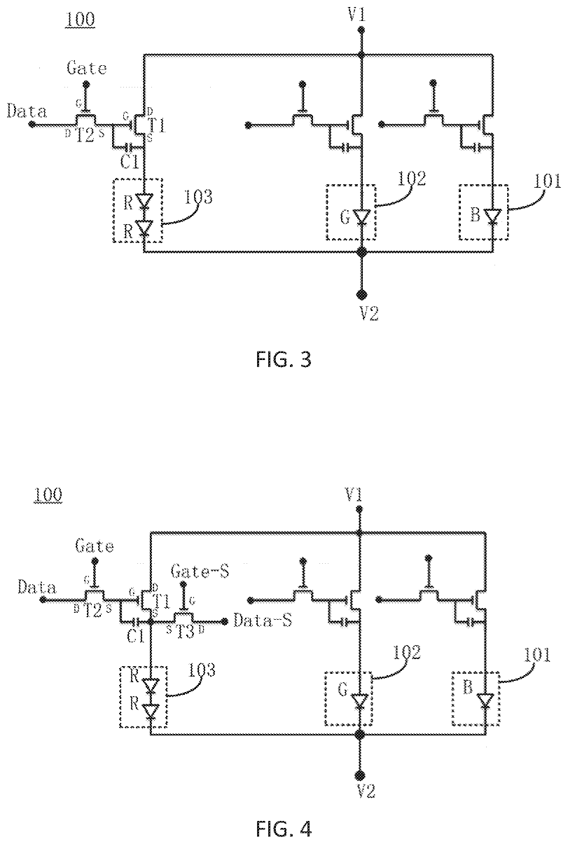

In one embodiment, referring to FIG. 2 and FIG. 3, the pixel driving circuit 100 further includes a first transistor T1, a second transistor T2 and a storage capacitor C1.

A first terminal of the first transistor T1 is connected to one terminal of the red light sub-pixel 103, a second terminal of the first transistor T1 is input with a first preset voltage V1, other terminal of the red light sub-pixel 103 is input with a second preset voltage V2, and a gate G of the first transistor is configured to receive a data signal Data to control light emitted by the red light sub-pixel 103. In particular, the first terminal of the first transistor T1 is one of a source S and a drain D of the first transistor T1, and the second terminal of the first transistor T1 is the other of the source S and the drain D of the first transistor T1. For example, as shown in FIG. 2, the first terminal of the first transistor T1 is the drain D of the first transistor T1, and the second terminal of the first transistor T1 is the source S of the first transistor T1. As shown in FIG. 3, another example, the first terminal of the first transistor T1 is the source S of the first transistor T1, and the second terminal of the first transistor T1 is the drain D of the first transistor T1.

One terminal of the storage capacitor C1 is connected to the gate G of the first transistor T1, and other terminal of the storage capacitor C1 is connected to the first terminal of the first transistor T1 or the second terminal of the first transistor T1.

In particular, the two manners in which the storage capacitor C1 is connected correspond to the second preset voltage V2 being a high voltage or a low voltage. If the second preset voltage V2 is a high voltage, then the first preset voltage V1 is a low voltage, and the storage capacitor C1 is connected to the second terminal of the first transistor T1. For example, as shown in FIG. 2, an anode of the red light sub-pixel 103 is input with a high voltage of 20 volts, a cathode of the red light sub-pixel 103 is connected to the drain D of the first transistor T1, and the source S of the first transistor T1 is input with a low voltage of 0.5 volts. One terminal of the storage capacitor C1 is connected to the gate G of the first transistor T1, and the other terminal of the storage capacitor C1 is connected to the source S of the first transistor T1. If the second preset voltage V2 is a low voltage, then the first preset voltage V1 is a high voltage, and the storage capacitor C1 is connected to the first terminal of the first transistor T1. For example, as shown in FIG. 3, a cathode of the red light sub-pixel 103 is input with a low voltage of 0.5 volts, an anode of the red light sub-pixel 103 is connected to the source S of the first transistor T1, and the drain D of the first transistor T1 is input with a high voltage of 20 volts. One terminal of the storage capacitor C1 is connected to the gate G of the first transistor T1, and the other terminal of the storage capacitor C1 is connected to the source S of the first transistor T1.

A gate G of the second transistor T2 is configured to receive a scan signal Gate, an input terminal of the second transistor T2 is configured to receive the data signal Data, an output terminal of the second transistor T2 is connected to the one terminal of the storage capacitor C1, and the data signal Data is transmitted to the gate G of the first transistor T1 passing the one terminal of the storage capacitor C1. In particular, the input terminal of the second transistor T2 is one of a source S and a drain D of the second transistor T2, and the output terminal of the second transistor T2 is the other of the source S and the drain D of the second transistor T2. For example, as shown in FIG. 2, the input terminal of the second transistor T2 is the drain D of the second transistor T2, and the output terminal of the second transistor T2 is the source S of the second transistor T2.

Referring again to FIG. 3, when the red light sub-pixel 103 is lit, a voltage VG of the gate G of the first transistor T1 is provided by the data signal Data received by the gate G of the first transistor T1, the data signal Data is controlled by a driving IC, and the value of the voltage that the data signal Data can provide generally has an upper limit. When the red light sub-pixel 103 is in a lit state, since the number of the red LEDs R of the red light sub-pixel 103 is increased, under the condition of reaching the same level of the red light brightness, the driving current of the red light sub-pixel 103 will decrease, while the voltage drop of the red light sub-pixel 103 will increase. And because the second preset voltage V2 input at the cathode of the red light sub-pixel 103 will not change, the voltage at the anode of the red light sub-pixel 103, that is, the voltage VS at the first terminal (source S) of the first transistor T1 will increase. Furthermore, since the voltage VGS of the first transistor T1, i.e., the voltage difference between VG and VS is fixed in a lit state, a higher voltage value of VG is required.

For example, V2 is a low voltage of 0.5 volts, the voltage drop of a single red LED R in a lit state is 1.7 volts, and the voltage VGS of the first transistor T1 is 4 volts. If the red light sub-pixel 103 includes one red LED R, then when the red light sub-pixel 103 is in a lit state, the voltage VS is 2.2 volts, and the required voltage VG provided by the data signal Data is 6.2 volts. If the red light sub-pixel 103 includes two red LEDs R, then when the red light sub-pixel 103 is in a lit state, the voltage VS is 3.9 volts, and the required voltage VG provided by the data signal Data is 7.9 volts. That is, when the number of the red LEDs R of the red light sub-pixel 103 is increased from one to two, since the voltage drop of the red light sub-pixel 103 is increased from 2.2 volts to 3.9 volts, the required voltage value provided by the data signal Data is increased from 6.2 volts to 7.9 volts. In this way, when the voltage drop of the red light sub-pixel 103 increases and therefore leads to a required voltage VG of the first transistor T1 being greater than the maximum voltage the data signal Data can provide, for example, when the required voltage VG of the first transistor T1 is 7.9 volts, and the maximum voltage the data signal Date can provide is 7.5 volts, a problem of display error will occur.

In one embodiment, referring to FIG. 4, when the other terminal of the storage capacitor C1 is connected to the first terminal (source S) of the first transistor T1, that is when the first preset voltage V1 is greater than the second preset voltage V2, the anode of the red light sub-pixel 103 is connected to the first terminal (source S) of the first transistor T1, the second terminal (drain D) of the first transistor T1 is input with the high voltage V1, and the cathode of the red light sub-pixel 103 is input with the low voltage V2, the pixel driving circuit 100 can further include a third transistor T3 to avoid the problem of display error that occurs when the voltage drop of the red light sub-pixel 103 increases and therefore leads to a required voltage VG of the first transistor T1 being greater than the maximum voltage the data signal Data can provide In particular, an input terminal (drain D) of the third transistor T3 is configured to receive a compensation data signal Data-S, an output terminal (source S) of the third transistor T3 is connected to the other terminal of the storage capacitor C1, and a gate G of the third transistor T3 is configured to receive a compensation scan signal Gate-S. When the red light sub-pixel 103 is lit, the compensation data signal Date-S transmitting through the input terminal (drain D) of the third transistor T3 and the data signal Data transmitting through the input terminal (drain D) of the second transistor T2 together charge the storage capacitor C1, and the storage capacitor C1 being finished charging discharges to make the red light sub-pixel 103 illuminate.

The input terminal of the third transistor T3 is one of a source S and a drain D of the third transistor T3, and the output terminal of the third transistor T3 is the other of the source S and the drain D of the third transistor T3. For example, as shown in FIG. 4, the input terminal of the third transistor T3 is the drain D of the third transistor T3, and the output terminal of the third transistor T3 is the source S of the third transistor T3.

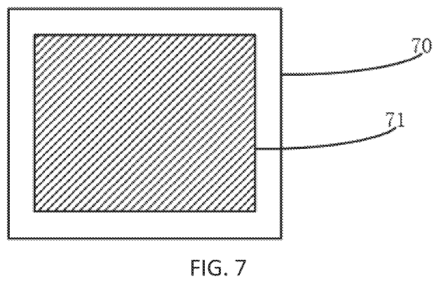

In some embodiments, as shown in FIG. 6, the pixel driving circuit 100 can further include a first scan line Gateline, a first data line Dataline, a second scan line Gateline-S and a second data line Dataline-S. The first scan line Gateline is connected to the gate G of the second transistor T2 and is configured to provide the scan signal Gate. The first data line Dateline is connected to the input terminal of the second transistor T2 and is configured to provide the data signal Data. The second scan line Gateline-S is connected to the gate of the third transistor T3 and is configured to provide the compensation scan signal Gate-S. The second data line Dateline-S is connected to the input terminal of the third transistor T3 and is configured to provide the compensation data signal Data-S.

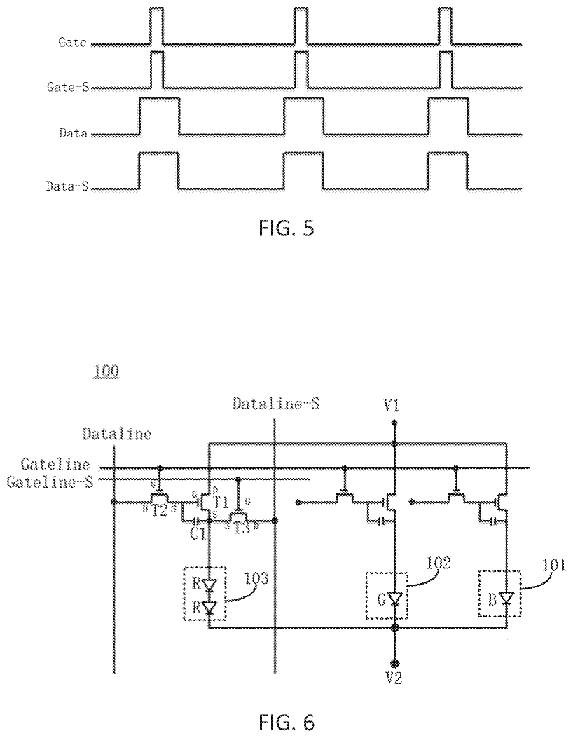

As shown in FIG. 5, a timing of the scan signal Gate can be the same as a timing of the compensation scan signal Gate-S, and a timing of the data signal Data can be the same as a timing of the compensation data signal Data-S, that is, a driving time of the first scan line Gateline can be the same as a driving time of the second scan line Gateline-S, and a driving time of the first data line Dataline can be the same as a driving time of the second data line Dataline-S.

In particular, referring again to FIG. 4, when the red light sub-pixel 103 is lit, firstly the first terminal (drain D) of the second transistor T2 receives the data signal Data, and meanwhile the first terminal (drain D) of the third transistor T3 receives the compensation data signal Data-S. Then the gate G of the second transistor T2 receives the scan signal Gate, and meanwhile the gate G of the third transistor T3 receives the compensation scan signal Gate-S. And then the data signal Data is transmitted to one terminal of the storage capacitor C1 through the second terminal (source S) of the second transistor T2, and meanwhile the compensation data signal Data-S is transmitted to the other terminal of the storage capacitor C1 through the second terminal (source S) of the third transistor T3, and the data signal Data and the compensation data signal Data-S can together charge the storage capacitor. Because of the capacitive coupling effect of the storage capacitor C1, after the storage capacitor C1 is finished charging, the voltage VG of the gate G of the first transistor T1 will increase, and the required voltage value provided by the data signal Data can be lowered.

For example, the second preset voltage V2 is 0.5 volts, the voltage drop of a single red LED R when lit is 1.7 volts, the VGS voltage of the first transistor T1 is 4 volts, and the red light sub-pixel 103 includes two red LEDs R. If the voltage value provided by the compensation data signal Data-S is 1 volt, then when the data signal Data and the compensation data signal Data-S together charge the storage capacitor C1, the voltage VG of the gate G of the first transistor T1 will increase 1 volt due to capacitive coupling effect. Then the storage capacitor C1 that is finished charging discharges to make the red light sub-pixel 103 illuminate. As can be seen from above, the voltage drop of the red light sub-pixel 103 when lit is 3.4 volts and the corresponding VS is 3.9 volts, and because the VGS voltage is 4 volts, the required voltage VG to ensure that the red light sub-pixel 103 can normally illuminate is 7.9 volts. Because the capacitive coupling effect of the storage capacitor C1 before the red light sub-pixel 103 is lit, the voltage VG of the gate G of the first transistor T1 has been increased 1 volt, and therefore the required voltage value provided by the data signal Data is 6.9 volts when the red light sub-pixel 103 is lit. (If the third transistor T3 is absent, then the required voltage value provided by the data signal Data is 7.9 volts.) In this way, by adding the third transistor T3, the required voltage value provided by the data signal Data can be lowered, and therefore the problem of display error that occurs when the required voltage VG of the first transistor T1 is greater than the maximum voltage the signal data Data can provide can be avoided.

In particular, the voltage value provided by the compensation data signal Data-S is less than the illuminated voltage value of the red light sub-pixel 103, that is, as shown in FIG. 4, in the course when the compensation data signal Data-S is charging the storage capacitor C1, the voltage value transmitted to the anode of the red light sub-pixel 103 passing the other terminal of the storage capacitor C1 is less than the illuminated voltage value of the red light sub-pixel 103 to avoid abnormal illuminating of the red light sub-pixel 103.

In the above embodiment, the difference between the first preset voltage V1 and the second preset voltage V2 is greater than or equal to the threshold voltage of the first transistor T1 to ensure that the driving current can be generated to light up the red light sub-pixel 103 when the storage capacitor is discharging. Besides, the first transistor T1, the second transistor T2 and the third transistor T3 can be MOS transistors.

It should be noted that when the blue light sub-pixel 101 includes multiple blue LEDs B in series or when the green light sub-pixel 102 includes multiple green LEDs G in series, the same approach as described above can be adopted to solve the above mentioned problem.

Distinctive from the conventional technology, the pixel driving circuit of the present embodiment includes a blue light sub-pixel, a green light sub-pixel and a red light sub-pixel in parallel with each other. The blue light sub-pixel includes at least one blue LED, the green light sub-pixel includes at least one green LED, and the red light sub-pixel includes at least two red LEDs in series with each other. The number of the red LEDs is greater than the number of the blue LED and the number of the green LED. In this way, the driving current of the red light sub-pixel can be decreased under the condition of reaching the same level of brightness and therefore the total current in the display panel is decreased and the uniformity of light emitted by the display panel is increased.

Referring to FIG. 7, FIG. 7 is a structural schematic diagram of the display device according to an embodiment of the present application. As shown in FIG. 7, the display device 70 includes the pixel driving circuit 71 as described in any of the above embodiments. The pixel driving circuit 71 includes a blue light sub-pixel, a green light sub-pixel and a red light sub-pixel in parallel with each other. The blue light sub-pixel includes at least one blue LED, the green light sub-pixel includes at least one green LED, and the red light sub-pixel includes at least two red LEDs in series with each other. The number of the red LEDs is greater than the number of the blue LED and the number of the green LED.

Distinctive from the conventional technology, the display device of the present embodiment includes a blue light sub-pixel, a green light sub-pixel and a red light sub-pixel in parallel with each other. The blue light sub-pixel includes at least one blue LED, the green light sub-pixel includes at least one green LED, and the red light sub-pixel includes at least two red LEDs in series with each other. The number of the red LEDs is greater than the number of the blue LED and the number of the green LED. In this way, the driving current of the red light sub-pixel can be decreased under the condition of reaching the same level of brightness and therefore the total current in the display panel is decreased and the uniformity of light emitted by the display panel is increased.

The present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

What is claimed is:

1. A pixel driving circuit, comprising:
a blue light sub-pixel, a green light sub-pixel, and a red light sub-pixel in parallel with each other;
wherein the blue light sub-pixel includes at least one blue light emitting diode (LED), the green light sub-pixel includes at least one green LED, the red light sub-pixel includes at least two red LEDs in series with each other, and a number of the red LEDs is greater than a number of the blue LED and a number of the green LED.

2. The pixel driving circuit as claimed in claim 1, further comprising:
a first transistor, wherein a first terminal of the first transistor is connected to one terminal of the red light sub-pixel, a second terminal of the first transistor is input with a first preset voltage, other terminal of the red light sub-pixel is input with a second preset voltage, and a gate of the first transistor is configured to receive a data signal to control light emitted by the red light sub-pixel;
a storage capacitor, wherein one terminal of the storage capacitor is connected to the gate of the first transistor, and other terminal of the storage capacitor is connected to the first terminal of the first transistor or the second terminal of the first transistor;
a second transistor, wherein a gate of the second transistor is configured to receive a scan signal, an input terminal of the second transistor is configured to receive the data signal, an output terminal of the second transistor is connected to the one terminal of the storage capacitor, and the data signal is transmitted to the gate of the first transistor passing the one terminal of the storage capacitor.

3. The pixel driving circuit as claimed in claim 2, wherein the first terminal is one of a source and a drain of the first transistor, and the second terminal is the other of the source and the drain of the first transistor.

4. The pixel driving circuit as claimed in claim 2, wherein when the other terminal of the storage capacitor is connected to the first terminal of the first transistor, the first preset voltage is greater than the second preset voltage, and the pixel driving circuit further comprises:
a third transistor, wherein an input terminal of the third transistor is configured to receive a compensation data signal, an output terminal of the third transistor is connected to the other terminal of the storage capacitor, and a gate of the third transistor is configured to receive a compensation scan signal;
wherein when the red light sub-pixel is lit, the compensation data signal transmitting through the input terminal of the third transistor and the data signal transmitting through the input terminal of the second transistor together charge the storage capacitor, and the storage capacitor being finished charging discharges to make the red light sub-pixel illuminate.

5. The pixel driving circuit as claimed in claim 4, wherein the input terminal of the second transistor is one of a source and a drain of the second transistor, the output terminal of the second transistor is the other of the source and the drain of the second transistor, the input terminal of the third transistor is one of a source and a drain of the third transistor, and the output terminal of the third transistor is the other of the source and the drain of the third transistor.

6. The pixel driving circuit as claimed in claim 4, wherein a voltage value provided by the compensation data signal is less than an illuminated voltage value of the red light sub-pixel.

7. The pixel driving circuit as claimed in claim 4, further comprising:
a first scan line connected to the gate of the second transistor and configured to provide the scan signal;
a first data line connected to the input terminal of the second transistor and configured to provide the data signal;
a second scan line connected to the gate of the third transistor and configured to provide the compensation scan signal;
a second data line connected to the input terminal of the third transistor and configured to provide the compensation data signal.

8. The pixel driving circuit as claimed in claim 7, wherein a driving time of the first scan line is the same as a driving time of the second scan line, and a driving time of the first data line is the same as a driving time of the second data line.

9. The pixel driving circuit as claimed in claim 1, wherein a difference between the first preset voltage and the second preset voltage is greater than or equal to a threshold voltage of the first transistor.

10. The pixel driving circuit as claimed in claim 1, wherein the at least one blue LED is one blue LED, the at least one green LED is one green LED, and the at least two red LEDs in series with each other are two red LEDs in series with each other.

11. A display device comprising a pixel driving circuit, wherein the pixel driving circuit comprises:
a blue light sub-pixel, a green light sub-pixel and a red light sub-pixel in parallel with each other;
wherein the blue light sub-pixel includes at least one blue light emitting diode (LED), the green light sub-pixel includes at least one green LED, the red light sub-pixel includes at least two red LEDs in series with each other, and a number of the red LEDs is greater than a number of the blue LED and a number of the green LED.

12. The display device as claimed in claim 11, wherein the pixel driving circuit further comprises:
a first transistor, wherein a first terminal of the first transistor is connected to one terminal of the red light sub-pixel, a second terminal of the first transistor is input with a first preset voltage, other terminal of the red light sub-pixel is input with a second preset voltage, and a gate of the first transistor is configured to receive a data signal to control light emitted by the red light sub-pixel;
a storage capacitor, wherein one terminal of the storage capacitor is connected to the gate of the first transistor, and other terminal of the storage capacitor is connected to the first terminal of the first transistor or the second terminal of the first transistor;
a second transistor, wherein a gate of the second transistor is configured to receive a scan signal, an input terminal of the second transistor is configured to receive the data signal, an output terminal of the second transistor is connected to the one terminal of the storage capacitor, and the data signal is transmitted to the gate of the first transistor passing the one terminal of the storage capacitor.

13. The display device as claimed in claim 12, wherein the first terminal is one of a source and a drain of the first transistor, and the second terminal is the other of the source and the drain of the first transistor.

14. The display device as claimed in claim 12, wherein when the other terminal of the storage capacitor is connected to the first terminal of the first transistor, the first preset voltage is greater than the second preset voltage, and the pixel driving circuit further comprises:
a third transistor, wherein an input terminal of the third transistor is configured to receive a compensation data signal, an output terminal of the third transistor is connected to the other terminal of the storage capacitor, and a gate of the third transistor is configured to receive a compensation scan signal;
wherein when the red light sub-pixel is lit, the compensation data signal transmitting through the input terminal of the third transistor and the data signal transmitting through the input terminal of the second transistor together charge the storage capacitor, and the storage capacitor being finished charging discharges to make the red light sub-pixel illuminate.

15. The display device as claimed in claim 14, wherein the input terminal of the second transistor is one of a source and a drain of the second transistor, the output terminal of the second transistor is the other of the source and the drain of the second transistor, the input terminal of the third transistor is one of a source and a drain of the third transistor, and the output terminal of the third transistor is the other of the source and the drain of the third transistor.

16. The display device as claimed in claim 14, wherein a voltage value provided by the compensation data signal is less than an illuminated voltage value of the red light sub-pixel.

17. The display device as claimed in claim 14, wherein the pixel driving circuit further comprises:
a first scan line connected to the gate of the second transistor and configured to provide the scan signal;
a first data line connected to the input terminal of the second transistor and configured to provide the data signal;
a second scan line connected to the gate of the third transistor and configured to provide the compensation scan signal;
a second data line connected to the input terminal of the third transistor and configured to provide the compensation data signal.

18. The display device as claimed in claim 17, wherein a driving time of the first scan line is the same as a driving time of the second scan line, and a driving time of the first data line is the same as a driving time of the second data line.

19. The display device as claimed in claim 11, wherein a difference between the first preset voltage and the second preset voltage is greater than or equal to a threshold voltage of the first transistor.

20. The display device as claimed in claim 11, wherein the at least one blue LED is one blue LED, the at least one green LED is one green LED, and the at least two red LEDs in series with each other are two red LEDs in series with each other.
